(19) United States
(12) Patent Application Publication
(10) Pub. No.: US 2026/0141055 A1
(43) Pub. Date: May 21, 2026

(54) System and Method for Granular Application Signatures

(71) Applicant: PC Matic Inc, SIOUX CITY, IA (US)

(72) Inventors: Robert J. Cheng, Myrtle Beach, SC (US); Matthew Quincy Riley, Owosso, MI (US)

(73) Assignee: PC Matic Inc, SIOUX CITY, IA (US)

(21) Appl. No.: 18/953,616

(22) Filed: Nov. 20, 2024

(51) Int. Cl. G06F 21/54

(52) U.S. Cl. CPC G06F 21/54; G06F 2221/034

(57) ABSTRACT

A system for computer security includes a signature of a signed library embedded in a program along with a set of transformations that were made during compiling and linking of the program. Computer security software periodically runs and opens the program (all programs) and when the program includes transformations, the computer security software rolls back the transformations to create a copy of the program then the computer security software calculates a check value on the copy and if the check value matches the signature, the program is allowed, otherwise the libraries/program has been compromised and the program is blocked and quarantined.

### FIELD OF THE INVENTION

This invention relates to computer security and more particularly to a system and method for improving signatures in applications.

### BACKGROUND OF THE INVENTION

Currently, when trusted software companies release a program or application, the trusted software company includes a signature. This is sometimes referred to as signing executables and/or scripts. The signature process utilizes a cryptographic process to validate the authenticity and integrity of the executables and/or scripts, including a cryptographic hash value that is used to make sure that the program or script hasn't been tampered with. Code signing implementations of the digital signature mechanism to verify the identity of the creator of the program and/or script or to identify the system that built the software and/or script. The code signing implementation includes some form of checksum to verify that the program and/or script has not been modified.

For most programs or scripts, libraries are included in the program or script. These libraries are often provided by third parties and are either fully or partially embedded into the program or script, called static libraries, or are loaded on-demand when the program or script runs called dynamic library. With static linking, the library is included in the program and distributed as part of the program. With dynamic linking, the library is distributed in a separate file that is distributed by the creator of the library and when the library is needed, the file is loaded into memory and the subroutines of the file are dynamically linked to the program/script for execution as needed.

These libraries often simplify the task of creating programs or scripts by providing building blocks that, without which, would require many resources to create, code, and test. Take for example a library of mathematical functions. Many programmers are very capable of writing a subroutine that will calculate the square root of a given number, but it is much more efficient to use an existing mathematical library that already contains a subroutine (or function) that calculates a square root, and that subroutine has already been tested, for example, tested to make sure the correct result is returned when the square root subroutine is given the value of zero as an input, making sure the proper value is returned (e.g. zero), and that no program exception occurs. Often the library is provided by a third party and sometime the third party includes software in their libraries that comes from another third party, etc. (nesting).

Today, when a program or script is released and is trusted, the software company that created that program or script will sign the program or script providing a level of trust to those using the program or script and providing a known reporting mechanism should malware be found in the program or script. This inclusion of libraries from a multitude of third parties, nested or not, makes it very difficult to understand from where any portion of the program and/or script emanated. For example, if the program or script performs complex mathematical functions, it is possible that the creator of the program or script employed any one of hundreds of libraries that are available for providing mathematical functions, the libraries created by development organizations all over the world.

Even when provided with a bill of materials from the creator of the program or script, the user/company cannot verify that the bill of materials is accurate and contains the libraries listed in the bill of materials and contains no additional libraries.

When a security exploitation occurs (e.g., malware affects the user or company that has installed the program or script), there is no way to trace back to the origin of each included library.

Currently, dynamically linked libraries can have signatures and, as long as these dynamically linked libraries don't have embedded static libraries, there is suitable protection and traceability. The problem that needs to be solved is validating and tracing back the libraries that are included within a program or script (static libraries) as there is currently no fine-grain mechanism for signing each library and sub library.

What is needed is a signature in each library that is embedded into a program or script.

### SUMMARY OF THE INVENTION

By embedding a signature in each library that is included in a program or script, security software is able to assure that the program and each of the included libraries are from known providers and that neither the program/script nor any of the libraries have been compromised.

The disclosed system for computer security includes a signature of a signed library embedded in a program along with a set of transformations that were made during compiling and linking of the program. Note that the described invention will also work with reproducible builds or deterministic compilation (e.g., the compiler emits the same binary for the same source code each time it is compiled). Computer security software periodically runs and opens the program (all programs) and when the program includes transformations, the computer security software rolls back the transformations to create a copy of the program then the computer security software calculates a check value on the copy and if the check value matches the signature, the program is allowed, otherwise the libraries/program has been compromised and the program is blocked and quarantined.

In one embodiment, a system for computer security is disclosed including at least one signed library that will be included in a program. During manufacture of the program, a signature from the library is included in the program along with all transformations that are made by the compiler/linker are recorded and stored in the program. A computer security program periodically runs on a processor of protected device and opens the program. When the security program determines that there exist transformations that were recorded and stored in the program, the computer security program rolls back the transformations to create a copy of the program then calculates a check value of the copy of the program. The computer security program compares the check value of the copy of the program with the signature stored in the program and when the check value of the copy of the program matches the signature stored in the program, the program is allowed. When the check value of the copy of the program does not match the signature stored in the program, the program is blocked (e.g., reported, quarantined).

In another embodiment, a method for computer security is disclosed including providing at least one signed library that will be included in a program then, during manufacture of the program, including a signature from the signed library in the program. In addition, during manufacture of the program, recording all transformations that are made by the compiler/linker and storing the transformations in/with the program. A security program periodically running on a processor of a protected device opens the program and when the security program determines that there exist transformations that were recorded and stored in the program, the security program rolls back the transformations and creates a copy of the program. The security program calculates a check value of the copy of the program and compares the check value of the copy of the program with the signature stored in the program and when the check value of the copy of the program matches the signature stored in the program, the program is allowed by the security program. When the check value of the copy of the program does is not matching the signature stored in the program, the program is blocked by the security program (e.g., recorded and quarantined).

In another embodiment, a system for computer security is disclosed including at least one signed library that will be included in a program. During manufacture of the program, there is software for including a signature from the signed library in the program. Also, during manufacture of the program, there is software for recording and storing all transformations that are made by the compiler/linker in or with the program. There is a computer security program that includes software for rolling back the transformations. Periodically, the computer security program runs on a processor of protected device, the computer security program opens the program and when the security program determines that there exist transformations that were recorded and stored in the program, the computer security program rolls back the transformations using the software for rolling back the transformations to create a copy of the program. The computer security program calculates a check value of the copy of the program and compares the check value of the copy of the program with the signature stored in the program and when the check value of the copy of the program matches the signature stored in the program, the program is allowed. Otherwise, when the check value of the copy of the program does not match the signature stored in the program, the program is blocked.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a program and dynamic library of the prior art.

FIG. 2 illustrates a schematic view of a typical computer protected by a computer security system.

FIG. 3 illustrates a program and dynamic library per the present invention.

FIG. 4 illustrates an exemplary hierarchy of signatures in a program of the present invention.

FIG. 5 illustrates an exemplary execution environment with the computer security system monitoring the signatures of the program.

FIGS. 6-7 illustrate exemplary program flows of the computer security system during creation of a program.

FIG. 8 illustrates an exemplary program flow of the computer security system in the execution environment.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

In general, computer programs (e.g., applications) and dynamic libraries often contain signatures that are used to validate the creator of each computer program. For programs, a program that includes a signature is referred to as a signed executable. The signature includes a cryptographically protected block of data that identifies the creator of the program and includes a cryptographic hash value that is used to make sure that the program (or script) hasn't been tampered with or modified. If a hacker modifies the program to add malware, the cryptographic hash value will not calculate to what is stored in the cryptographically protected block and, therefore, protection software will recognize such and prevent execution of the program and/or quarantine the program. Protection software utilizes a cryptographic process to validate the authenticity and integrity of the executables and/or scripts, including calculating the cryptographic hash value and comparing the calculated hash value to a stored hash value to make sure that the program or script has not been tampered with. Code signing implementations of the digital signature mechanism are also used to verify the identity of the creator of the program and/or script or to identify the system that built the software and/or script.

Throughout this description, the term, “device” refers to any system that has a processor and runs software. Examples of such are: a personal computer, a server, a notebook computer, a tablet computer, a smartphone, a smart watch, a smart television, etc. The term, “user” refers to a human that has an interest in the device, perhaps a person (user) who is using the device.

Throughout this description, the term “directory” or “directory path” describes a hierarchical pathway to a particular folder in which files (e.g., data or programs) are stored for access by the device. For example, “C:/windows/system32” refers to files stored in a folder called “system32” which is a subfolder of another folder called “windows” which is a top-level folder of a storage device known as “C.” Note that the storage device (e.g., C:) is at times a physical device (e.g., a separate disk drive) or a logical device (e.g., a portion of a local or remote storage). Also note that the described representation (e.g., “C:/windows/system32”) is a human-readable representation of such hierarchy used by certain operating systems and any such representation is anticipated and included herein (e.g., some representations use backslashes instead of slashes).

Throughout this description, the term, “malicious software” or “malware” refers to any software having ill-intent. Many forms of malicious software are known; some that destroy data on the host computer; some that capture information such as account numbers, passwords, etc.; some that fish for information (phishing), pretending to be a known entity to fool the user into providing information such as bank account numbers; some encrypt data on the computer and hold the data at ransom, etc. A computer virus is a form of malicious software.

Throughout this document, the term program will refer to any item that potentially runs on the device, including, but not limited to software programs, scripts, and macros.

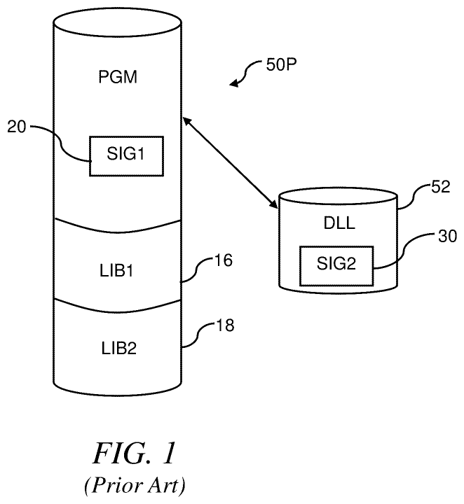

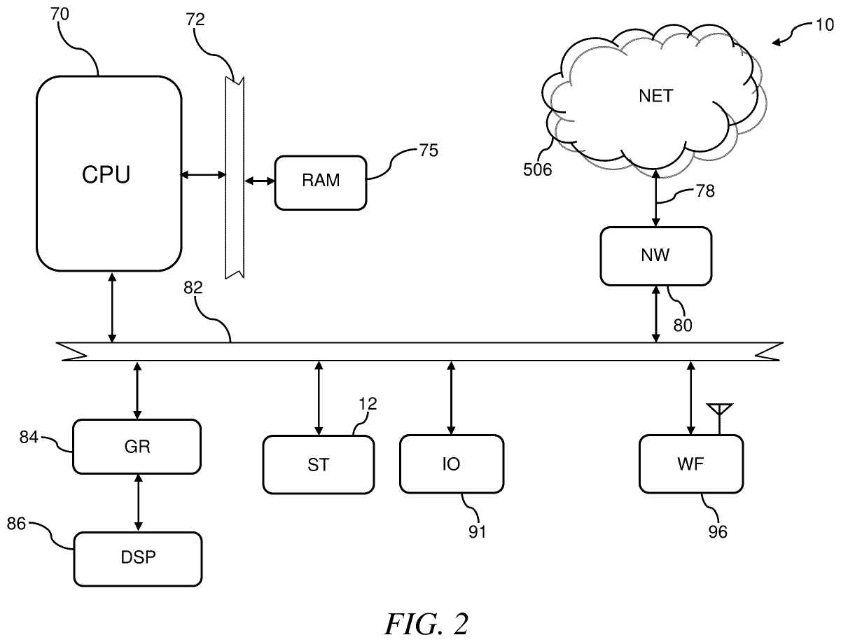

Referring to FIG. 1, a program 50P and dynamic library 52 of the prior art are shown. In this example, the program 50P includes two libraries 16/18 and the program 50P also references a dynamic library 52. The program 52P includes a signature 20 that includes a signature 20. Likewise, since the dynamic library 52 is stored in a separate file that is loaded into the memory 75 (see FIG. 2) of the device 10 (see FIG. 2), the dynamic library 52 includes a second signature 30. The signature 20 is a cryptographically protected block of data that identifies the creator of the program 50B and, in some embodiments, includes a cryptographic hash value that is used to make sure that the program 50P (or script) hasn't been tampered or modifies since the program 50P was created.

Referring to FIG. 2, a schematic view of a typical device 10 is shown. The computer security system software 17 runs on the target device 10 (any processor-based device) for providing protection against programs/applications/scripts that contain malicious software (malware). The present invention is in no way limited to any particular target device 10. Protection for many processor-based devices is equally anticipated including, but not limited to smart phones, cellular phones, portable digital assistants, routers, thermostats, fitness devices, smart watches etc.

The target device 10 shown as an example represents a typical device that is protected by computer security system software 17. This exemplary device 10 is shown in its simplest form. Different architectures are known that accomplish similar results in a similar fashion, and the present invention is not limited in any way to any particular computer system architecture or implementation. In this target device 10, a processor 70 executes or runs programs in a random-access memory 75. The programs are generally stored within a persistent memory, storage 12, and loaded into the random-access memory 75 when needed. The processor 70 is any processor, typically a processor designed for phones. The random-access memory 75 is interfaced to the processor by, for example, a memory bus 72. The random-access memory 75 is any memory suitable for connection and operation with the selected processor 70, such as SRAM, DRAM, SDRAM, RDRAM, DDR, DDR-2, etc. The storage 12 is any type, configuration, capacity of memory suitable for persistently storing data, for example, flash memory, read only memory, battery-backed memory, hard disk, etc. In some exemplary target computers 10, the storage 12 is removable, in the form of a memory card of appropriate format such as SD (secure digital) cards, micro-SD cards, compact flash, etc.

Also connected to the processor 70 is a system bus 82 for connecting to peripheral subsystems such as a cellular network interface 80, a graphics adapter 84 and user I/O devices 91 such as mice, keyboards, touchscreens, etc. The graphics adapter 84 receives commands from the processor 70 and controls what is depicted on the display 86. The user I/O devices 91 provides navigation and selection features.

In general, some portion of the storage 12 is used to store programs, executable code, and data, the whitelist 19, etc. In some embodiments, other data is stored in the storage 12 such as audio files, video files, text messages, etc.

The peripherals shown are examples, and other devices are known in the industry such as Global Positioning Subsystems, speakers, microphones, USB interfaces, cameras, microphones, Bluetooth transceivers, Wi-Fi transceivers 96, image sensors, temperature sensors, etc., the details of which are not shown for brevity and clarity reasons.

In some embodiments, a network interface 80 connects the target device 10 to the network 506 through any known or future protocol such as Ethernet, Wi-Fi, GSM, TDMA, LTE, etc., through a wired or wireless medium 78. There is no limitation on the type of connection used. In such, the network interface 80 provides data and messaging connections between the target device 10 and other computers through the network 506.

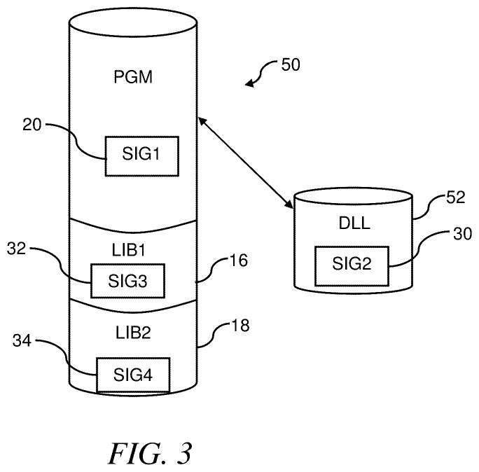

Referring to FIG. 3, a program 50 and dynamic library 52 of the present invention are shown. In this example, the program 50 includes two libraries 16/18 and the program 50 also references a dynamic library 52. The program 50 includes a signature 20. Likewise, since the dynamic library 52 is stored in a separate file that is loaded into the memory 75 (see FIG. 2) of the device 10 (see FIG. 2), the dynamic library 52 includes a second signature 30. The signatures 20/30 are cryptographically protected blocks of data that identify the creator of the program 50 or dynamic library 52 and, in some embodiments, the signatures 20/30 includes a cryptographic hash value that is used to make sure that the program 50 (or script) or dynamic library 52 hasn't been tampered or modified since the program 50 or dynamic library 52 was created.

In this embodiment, each library 16/18 that is embedded in the program 50 also has a signature 32/34.

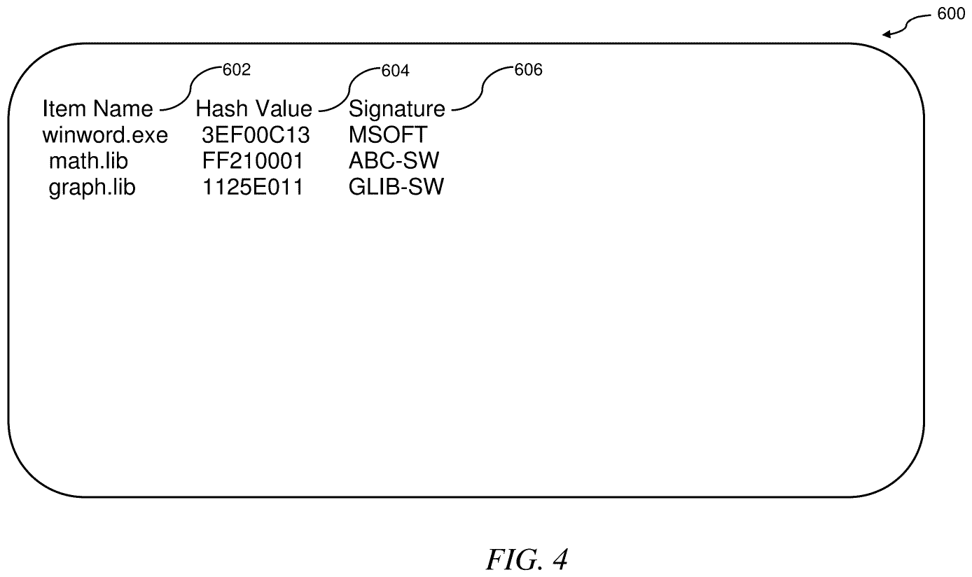

The table 600 of FIG. 4 depicts an exemplary hierarchy of signatures in a program 50 of the present invention. In this example, the table 600 includes the name of the item 602 (e.g., name of the program, dynamic library, and/or static library), the hash value 604 of the item, and the signature 606 of the item. The first item is a program 50 called winword.exe which has a hash value 604 and a signature 606. In this example, the signature 606 is by a company MSOFT. Typically, signatures are provided by signature authorities that assure the signature is legitimate. Imbedded in the program 50, winword.exe, are two libraries, math.lib and graph.lib, each having a hash value 604 and a signature 606. As will be shown, the computer security system 17 is programmed to monitor the programs and determine what libraries are included or linked and to make sure the signatures and hash values are correct, helping to assure that the program and the libraries have not been compromised.

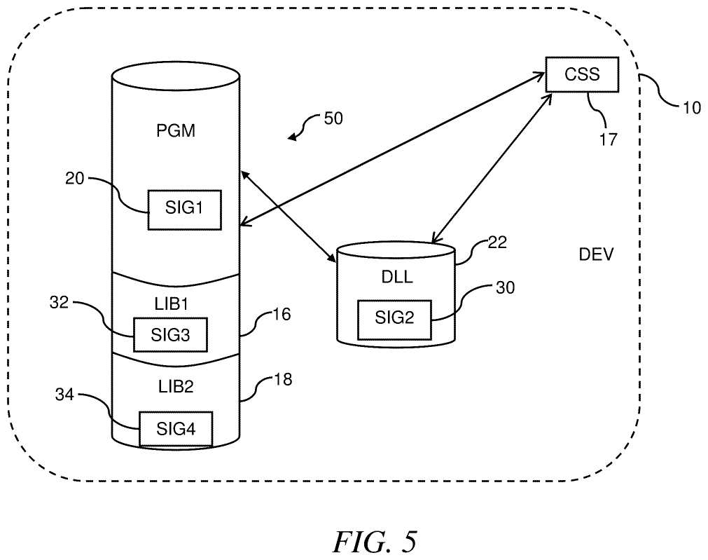

FIG. 5 illustrates an exemplary execution environment with the computer security system 17 monitoring the signatures of the program 50. In this example, the program 50 includes a signature 20 that covers the entire program 50. There are two static libraries 16/18 embedded in the program 50 and each of the static libraries 16/18 include their own signatures, SIG3 32 and SIG4 34. The program 50 also accesses/uses a dynamically linked library 22 which also has its own signature 30. As each signature 20/30/32/34 includes a hash value and mechanism to recognize tampering of the signature, the computer security system 17 is able to monitor the program to discover if the program 50 has been modified, as would happen if malicious software is introduced into the program 50. If malicious software is introduced into the program 50 or libraries 20/30/32/34, the computer security program 17 is able to discover such by way of an invalid signature and/or a hash value that does not match that of the program 50 and/or libraries 20/30/32/34 and the computer security program 17 will take action such as notifying a user or information technology personnel, preventing execution of the program 50, quarantining the program 50, sending the program 50 for analysis (e.g., by a researcher), etc.

As dynamically linked libraries 22 are stand-alone files that are installed onto the device 10 (e.g., computer), each dynamically linked library 22 will have a signature 30 with associated hash value 604 that is periodically checked by the computer security program 17 to make sure that these dynamically linked libraries 22 have not been tampered.

It is more difficult to sign/check statically linked libraries as when a statically linked library is embedded into a program 50, the compiler and linker often make optimizations or instruction selections or optimizations that render it difficult to maintain the signature. For example, many static libraries include a large number of functions while a typical program will use only a few of those functions. During compilation of the program 50, the compiler/linker will only include the functions that are used by the program 50 in the final executable. Therefore, the hash value of the library will not work provide ample protection as only part of the library in included in the program 50.

To work around the issue related to compiling and linking of a static library with a program 50, several solutions are presented.

A first solution is that the provider of the static library will provide one or more pre-compiled versions of the library, each of which having a signature with hash value. The program 50 is then compiled/linked with one or more of the pre-compiled (and signed) versions.

A second solution is to provide a new trust authority to which the author of the program 50 and the author of the static library submit signed source code. This new trust authority will then build (compile/link) the program 50 from the signed source code for the program 50 and library. The new trust authority is anticipated to be somewhat like an app store or similar.

A third solution is to provide a set of transformations that were made during compiling/linking that are reversable. For example, two different compilers/linkers will produce different executable code given the exact same source code. For example, if the source code is “A=B+C”, one compiler might generate assembly code (or intermediate code) that is: “mov R3, B; mov R4, C; add R3,R4, mov A,R3” and a different compile might generate: “mov R3, B; add R3,C; mov A, R3” In some compilers/linkers, these will be optimized to the same set of instruction, but in some compilers/linkers, these will be rendered as different instructions or in a different order. As such, for each compiled version of the program 50, the hash value will be different and, therefore, the maker of the static library will not be able to effectively sign the executable code with a hash value. The third solution requires that the compiler/linker provide a list of transformations that were made from the source code into the executable code so that the computer security program 17 is able to work backwards from the executable code to the source code and the source code is then assigned the hash value. Once the computer security program 17 rolls back the transformations to arrive back to the source code, the hash value of the source code is then compared to the hash value in the signature to determine if the static library was tampered.

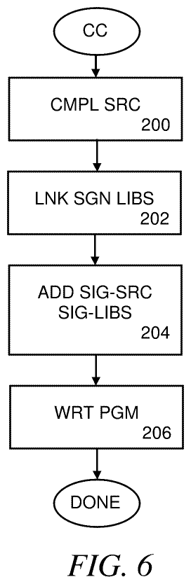

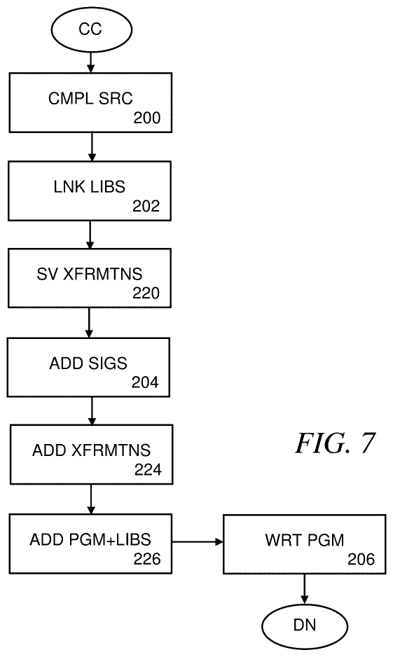

Referring to FIGS. 6-7, exemplary program flows of the computer security system during creation of a program are shown. In the example of FIG. 6, the developer compiles 200 the source code for the application or program 50 then links 202 various libraries that are used by the source code into the program 50. Next, signatures of each of the libraries are added 204 to the program 50. The program 50 with the signatures is then written 206 to a file (e.g., program.exe).

In the example of FIG. 7, again, the developer compiles 200 the source code for the application or program 50 then links 202 various libraries that are used by the source code into the program 50. In this example, the compiler/linker performs transformations on the libraries (e.g., code optimizations or changing the order of instructions). Therefore, a list of the transformations is saved 220 and the program is created to include 224 the list of transformations in the final program 50. Next, signatures of each of the libraries are added 204 and the libraries are added 226 to the program 50. The program 50 with the signatures, libraries and transformations is then written 206 to a file (e.g., program.exe).

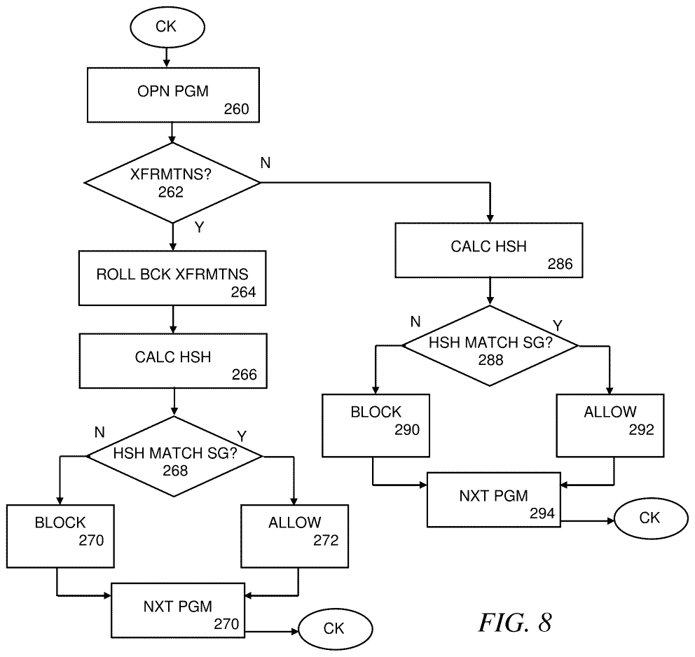

Referring to FIG. 8, an exemplary program flow of the computer security system in the execution environment is shown. The security software 17 running on the device 10 periodically checks programs 50 to determine if any tampering has been done, as for example a virus program performs scans for viruses. In the flow shown in FIG. 8, each program is opened 260, then if it is determined 262 that the compiler/linker provided a set of transformations that were performed during compiling and linking to create the program, The transformations are rolled back 264 to create a copy of the program that should match the signature if those transformations were not made. For example, if a compile performed an optimization such as converting a call instruction followed by a return instruction to a single jump instruction, this transformation is rolled back 264 to the original call instruction followed by a return instruction. After all the transformations are rolled back 264, the hash value (or other check value as known in the industry) is calculated 266 for the copy of the program and the calculated 266 hash value is compared with the signature value. If the hash value (or other check value as known in the industry) as calculated 266 matches the signature value 268, the program is allowed 272. If the hash value (or other check value as known in the industry) as calculated 266 does not match the signature value 268, the program is blocked 270 as a program would be blocked by a typical antivirus program (e.g., information about the program is recorded, the program is moved to a quarantine area, if running, the program is terminated).

If it is determined 262 that the compiler/linker di [symbol] not provide a set of transformations during compiling and linking, then the security software calculates 286 a hash value for the program (or other check value as known in the industry). If the hash value (or other check value as known in the industry) as calculated 286 matches the signature value 288, the program is allowed 292. If the hash value (or other check value as known in the industry) as calculated 286 does not match the signature value 288, the program is blocked 290 as a program would be blocked by a typical antivirus program (e.g., information about the program is recorded, the program is moved to a quarantine area, if running, the program is terminated).

The above is repeated for each program found on the target device, starting with the next program 294.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for computer security, the system comprising:
at least one signed library that will be included in a program;
during manufacture of the program, a signature from the at least one signed library is included in the program along with any transformations that are made by a compiler/linker are recorded and stored in the program;
a computer security program periodically runs on a processor of protected device, the computer security program opens the program and when the computer security program determines that there exist transformations that were recorded and stored in the program, the computer security program rolls back the transformations to create a copy of the program;
the computer security program calculates a check value of the copy of the program;
the computer security program compares the check value of the copy of the program with the signature stored in the program and when the check value of the copy of the program matches the signature stored in the program, the program is allowed; and
when the check value of the copy of the program does not match the signature stored in the program, the program is blocked.

2. The system of claim 1, wherein when the program is blocked, a record of the program is captured and the program is moved to a quarantine area of the protected device.

3. The system of claim 1, wherein the check value is a hash value.

4. The system of claim 1, wherein the check value is a checksum.

5. A method for computer security, the method comprising:
providing at least one signed library that will be included in a program;
during manufacture of the program, including a signature from the at least one signed library in the program;
also, during manufacture of the program, recording all transformations that are made by a compiler/linker and storing the transformations in the program;
a security program periodically running on a processor of a protected device and opening the program and when determining that there exist transformations that were recorded and stored in the program by the security program, rolling back the transformations and creating a copy of the program by the security program;
calculating a check value of the copy of the program by the security program;
comparing the check value of the copy of the program with the signature stored in the program by the security program and when the check value of the copy of the program matching the signature stored in the program, the program is allowed by the security program; and
when the check value of the copy of the program does is not matching the signature stored in the program, the program is blocked by the security program.

6. The method of claim 5, wherein when the program is blocked, capturing a record of the program and moving the program to a quarantine area of the protected device by the security program.

7. The method of claim 5, wherein the check value is a hash value.

8. The method of claim 5, wherein the check value is a checksum.

9. A system for computer security, the system comprising:
at least one signed library that will be included in a program;
during manufacture of the program, means for including a signature from the at least one signed library in the program;
also during manufacture of the program, means for recording and storing all transformations that are made by a compiler/linker in the program;
a computer security program that includes means for rolling back the transformations;
periodically, the computer security program runs on a processor of protected device, the computer security program opens the program and when the computer security program determines that there exist transformations that were recorded and stored in the program, the computer security program rolls back the transformations using the means for rolling back the transformations to create a copy of the program;
the computer security program calculates a check value of the copy of the program;
the computer security program compares the check value of the copy of the program with the signature stored in the program and when the check value of the copy of the program matches the signature stored in the program, the program is allowed; and
when the check value of the copy of the program does not match the signature stored in the program, the program is blocked.

10. The system of claim 9, wherein when the program is blocked, a record of the program is captured and the program is moved to a quarantine area of the protected device.

11. The system of claim 9, wherein the check value is a hash value.

12. The system of claim 9, wherein the check value is a checksum.
